(19) United States
(12) Patent Application Publication
(10) Pub. No.: US 2004/0219853 A1
(43) Pub. Date: Nov. 4, 2004

(54) Room finishing system

(76) Inventors: Charles R. Weir, Westerville, OH (US); Mark H. Smith, Newark, OH (US); Frederick R. Ernest, St. Louisville, OH (US); Bret A. Clippinger, Heath, OH (US); Jeffrey J. Van Sloun, Perrysburg, OH (US); Neil Hettler, Granville, OH (US)

Correspondence Address: OWENS CORNING, 2790 COLUMBUS ROAD, GRANVILLE, OH, 43023, US

(21) Appl. No.: 10/789,229

(22) Filed: Feb. 27, 2004

Related U.S. Application Data
(60) Provisional application No. 60/459,275, filed on Mar. 31, 2003.

(51) Int. Cl. B32B 27/12

(52) U.S. Cl. 442/327; 442/394

(57) ABSTRACT

The present invention provides a finished faced insulation system for use where a reduced thickness is desired for interior basement applications for walls not requiring thermal insulation (non-thermal gradient walls) and for the interior of basement walls where thermal insulation is required (thermal gradient walls). The insulation system of the present invention is also suitable for use on masonry walls, frame construction walls, and combined construction walls (knee-walls). The insulations system provides an insulative core having a first surface and a second surface, said first surface being suitable for exposure to an interior of a room, said second surface being suitable for being placed adjacent a wall; a decorative facer adhered to said first surface; and a structural facer adhered to said second surface.

### BACKGROUND OF THE INVENTION

1. Field of the Invention and Industrial Applicability

The present invention relates to finished rooms and methods of finishing a room. More particularly, the present invention relates to finished rooms that include insulation panels, and methods of finishing a room that include installing insulation panels. The present invention has industrial applicability in the insulating and finishing of rooms, especially otherwise unfinished rooms such as basements.

2. Description of the Invention's Background

It has been common for homeowners to buy a home with unfinished rooms, such as basements, and then later to finish such rooms when the homeowner has more money, or as the homeowner's family grows. It is also becoming more common for homeowners to specify that they want such historically unfinished rooms as basements in new houses finished at the time the houses are built. Builders are often reluctant to finish the basements of new residential constructions, however, because there is always a greater level of uncertainty during the first several years of a new construction's life as to whether foundation cracks or other problems will arise, and the existence of a finished basement generally makes repair of such defects more costly for the builder.

As used herein, the terms “finish”, “finishing” and “finished” refer to the process of installing, and a room that has, a wall surface that would normally be considered acceptable for use in such regularly inhabited rooms as bedrooms and family rooms. Examples of such acceptable wall surfaces include drywall, plaster, fabric, and wood or other paneling. A drywall or drop ceiling and a floor treatment such as tiling, carpeting or hardwood flooring would normally also be installed at the same time as the above-indicated wall surface, but these installations are not specifically required within the meaning of the terms “finish”, “finishing” and “finished” as used herein.

U.S. Pat. No. 3,721,050 to Perina discloses a modular grid panel retention system for use in structures such as the basements of industrial buildings, business establishments and the like. A framework is attached to a masonry wall, and panels are attached to the framework by complementary hook and loop fasteners. The panels may be translucent to allow indirect lighting of a basement from behind the panels. As stated in column 4, lines 47-66 of the Perina patent, the system of the Perina patent preferably includes spaces between the panels and the framework to allow simple removal of the panels from the framework. This feature is disadvantageous for the finishing of rooms, however, and especially the finishing of rooms in residential structures, because such spaces allow paths for the convection of heat between the interior of a basement and the masonry walls, and would destroy much of the insulative value that the system could otherwise have.

U.S. Pat. No. 5,606,833 to Andersson discloses a wall structure for the interior sound and thermal insulation of rooms, which includes one-piece metal fastening profiles attached to the walls of the room or to composite insulating members to hold the insulating members against the walls. The insulating members each include a soft insulating sheet fastened to a rigid support sheet, and the fastening profiles fasten the insulating members by inserting between the soft and rigid sheets and thus either attaching a particular insulating member directly to a wall, as shown in FIGS. 4 and 5 of the Andersson patent, or to an adjoining insulating member, as shown in FIGS. 7-10 of the Andersson patent.

The structure of the Anderson patent is disadvantageous, however, because it is constructed such that the rigid support sheets face outwardly into a room, which provides a relatively hard wall surface that is likely to be acoustically reflective over a wide midrange of frequencies (such as those common in human speech, television programs, etc.) and thus can tend to provide little acoustical insulation benefit. The structure of the Andersson patent is further disadvantageous because, due to the one-piece nature of the fastening profiles and their method of attachment to the insulating members, they require screw fastening to the insulating members at inside corners of the room, as shown in FIG. 7, at outside corners of the room, as shown in FIG. 8, and adjacent doors and windows, as shown in FIG. 9. Such screw attachments can be relatively time consuming to install, require additional time to cover to form an acceptably attractive wall surface, and make it difficult to achieve a nondestructive modular system in which wall panels can be easily removed and replaced.

U.S. Pat. No. 5,606,841 to Carter, Jr. discloses filled interior wall panels that may be specifically constructed to provide thermal and sound insulating properties, which panels include a rigid backing layer preferably constructed of plywood, a frame adhered to the backing layer about the periphery thereof, stuffing or filling material positioned within the frame, and a cover secured over the filling material and around the frame and attached to the back of the backing layer. Tufting buttons are then secured through the cover to the backing layer such that the outer surface of the panel has a tufted configuration to provide a unique visual relief. The panels are preferably secured to each other by a plurality of dowel pins frictionally fitting into holes in the frames. The panels of the Carter, Jr. patent have the disadvantage that they include a relatively large number of steps to manufacture, and that they appear to be relatively time consuming to install, due to the need to interconnect the panels with dowel pins.

One example of a common method of finishing a room in an attractive and insulative manner, such as a residential basement room having a cinder block wall, involves the attachment of wood studs roughly every 16 to 24 inches to the cinder block wall and the attachment of a wall surface such as drywall or paneling to the wood studs by attachment means such as nails or screws. Generally, insulation such as glass fiber insulation batts are placed between the wall and the wall surface before attachment of the wall surface to the wood studs, or a granular or loose-fill fibrous insulation is poured or blown in to the space between the wall and the wall surface after the wall surface is attached to the wood studs.

This method has certain drawbacks, however. Such a method is generally performed by a contractor at the time the room is built, or later by a contractor or a homeowner when the homeowner desires to finish the room. Often the most expensive component of a contractor's cost structure is labor. Thus, the above method, which is relatively time consuming to perform, is relatively costly for the contractor and thus the homeowner. Further, when a homeowner finishes a room such as a basement, i.e., in a do-it-yourself or DIY project, the homeowner often has limited experience performing the above method, and generally desires to spend as little as possible in materials to complete the project. The above method thus has the disadvantage that it requires a certain level of sophistication and ability with respect to building techniques. This disadvantage can tend to dissuade potential DIY'ers from undertaking the finishing of a room such as a basement.

Further, the attachment means common in such methods produce a finished wall structure that is relatively non-modular, i.e., in which it is very difficult to remove and then replace a wall panel in an aesthetically acceptable manner. Such modularity can be desirable to check for moisture behind the panel (especially in a new home), or to replace the panel with another panel such a decorative panel or a mirror.

The prior art method still further has the disadvantage in that it results in a relatively hard, dense material such as drywall exposed to the room. Such material often is relatively reflective of acoustic energy at a wide midrange of frequencies, and the structure can thus have less desirable acoustics. Such material also can be less desirable than softer, more resilient materials in areas such as playrooms where young children play and may often run into the walls.

In response to the prior art method Owens Corning introduced the Basement Wall Finishing System as disclosed in U.S. patent application Ser. No. 08/982,187, (Inventor: Traci Aloi et al.) entitled FINISHED ROOM AND METHOD OF FINISHING ROOM, herein incorporated in its entirety by express reference. The Aloi et al. application describes a system of finishing a basement in which 2.5 inch thick boards of rigid fiberglass insulation are adhered on one side with an aesthetically pleasing fabric. The fabric is typically a vapor permeable natural or artificial fiber fabric such as polyolefin. Each board is located between two adjacent frame members and releasably attached to the wall using snap-in rails.

### SUMMARY OF THE INVENTION

The present invention provides a finished faced insulation system for use where a reduced thickness is desired for interior basement applications for walls not requiring thermal insulation (non-thermal gradient walls) and for the interior of basement walls where thermal insulation is required (thermal gradient walls). The insulation system of the present invention is also suitable for use on masonry walls, frame construction walls, and combined construction walls (knee-walls).

A finished room of the present invention includes, in combination, a room having a wall, and a room finishing system including a plurality of first frame members attached to the wall, wherein each of the first frame members includes a first snap-in connector, a plurality of insulation panels composed of an insulating material, wherein each of the insulation panels is located between at least two of the first frame members, and a plurality of second frame members, wherein each of the second frame members includes a second, mating snap-in connector and wherein each of the second connectors is releasably connected to one of the first connectors.

The objects of the invention are also accomplished by method of finishing a room according to the present invention, which includes the steps of attaching a plurality of first frame members to a wall of the room, positioning a plurality of insulation panels against the wall, whereby each of the insulation panels is located between at least two of the first frame members, and releasably connecting each of a plurality of second frame members to one of the first frame members, wherein each of the second frame members includes at least one retaining arm and wherein the releasably connecting step includes retaining at least a portion of a respective one of the insulation panels between each one of the retaining arms and the wall. The present invention utilizes components that are not affected by moisture vapor and is intended for use in basements of residential buildings. The system is to allow moisture to pass through the fabric faced fiberglass panel and allows any water or water vapor at the basement wall to evaporate into the room interior. The vapor transmission rate of the faced fiberglass panel should be high enough to allow the insulation to dissipate moisture into the basement space such that the basement wall and the fabric faced fiberglass panel becomes dry prior to the next heating or cooling season, thus eliminating moisture build up in the wall system. The fabric faced fiberglass panel may be used to providing a thin, flat, rigid aesthetically pleasing product due to it's reinforced backside facing, fiberglass core material, and fabric exposed surface facing. The low R-value of the product allows use directly applied to a vapor barrier film on frame wall construction providing an insignificant effect on the dew point temperature of the vapor barrier film thus keeping the wall system dry.

### BRIEF DESCRIPTION OF THE DRAWINGS

The preferred embodiment of the present invention will be described in greater detail with reference to the accompanying drawings, wherein like members bear like reference numerals and wherein:

FIG. 1 is a perspective view of a portion of a finished room of the present invention including a finishing system of the present invention;

FIG. 2 is a cross sectional view of an inside corner of the room of FIG. 1;

FIG. 3 is a cross sectional view of an area of the room of FIG. 1 along the wall of the room spaced from the corners of the room;

FIG. 4 is a cross sectional view of the product of the present invention;

FIG. 5 is a cross sectional view of the present invention installed in an insulated exterior stud wall;

FIG. 6 is a cross sectional view of the present invention installed in an uninsulated block or poured concrete exterior wall; and

FIG. 7 is a cross sectional view of the present invention installed in a combination uninsulated block or poured concrete exterior wall and insulated exterior stud wall known as a knee wall.

### DETAILED DESCRIPTION OF THE PREFERRED EMBODIMENT

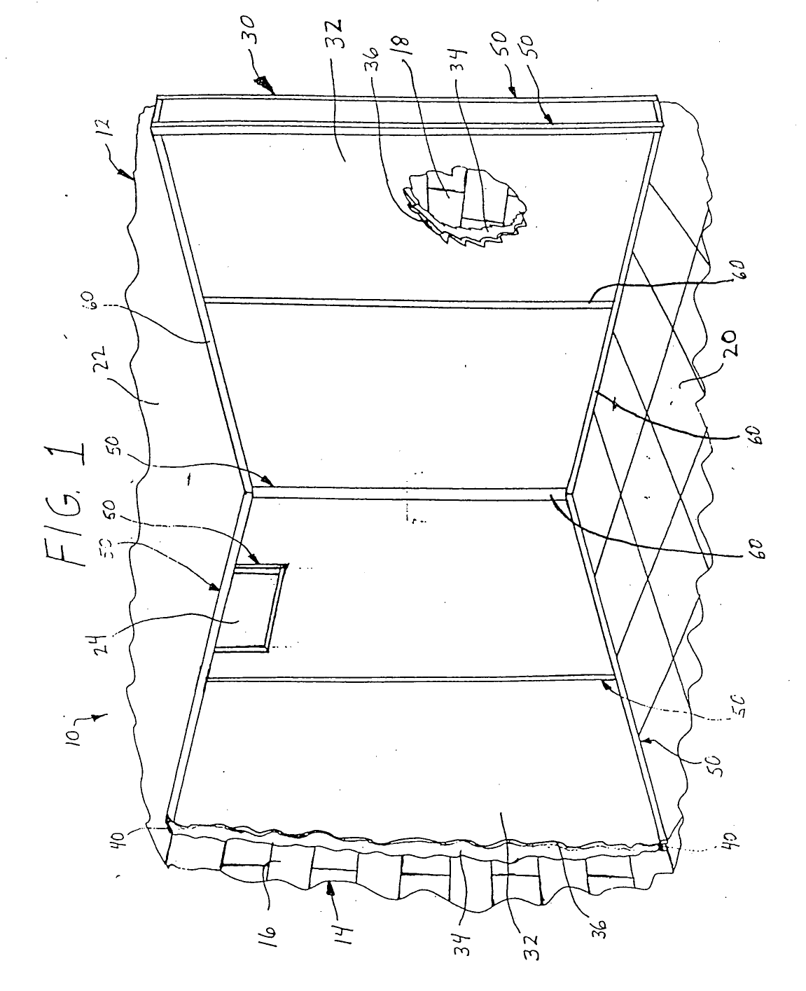

With reference to FIG. 1, a finished room 10 according to the present invention includes a room 12 having a wall 14. The room 12 is shown in FIG. 1 as being a residential basement room with cinder block walls, but may be any type of room that one might desire to finish, either in a residential or a commercial building. The wall 14 may include a first wall 16, a second wall 18 (shown through a partial breakaway of a covering insulation panel), and third, fourth, fifth, etc., walls (not shown). The room 12 also may include a floor 20 and a ceiling 22. The ceiling 22 is shown in the drawings for convenience as a drywall ceiling, but it could and often would be some form of a drop ceiling in a residential basement room. The floor 20 is shown as a tile floor, but it could be carpeted or otherwise covered. The wall 14 may have windows and doors therein, such as the window 24 in the first wall 16.

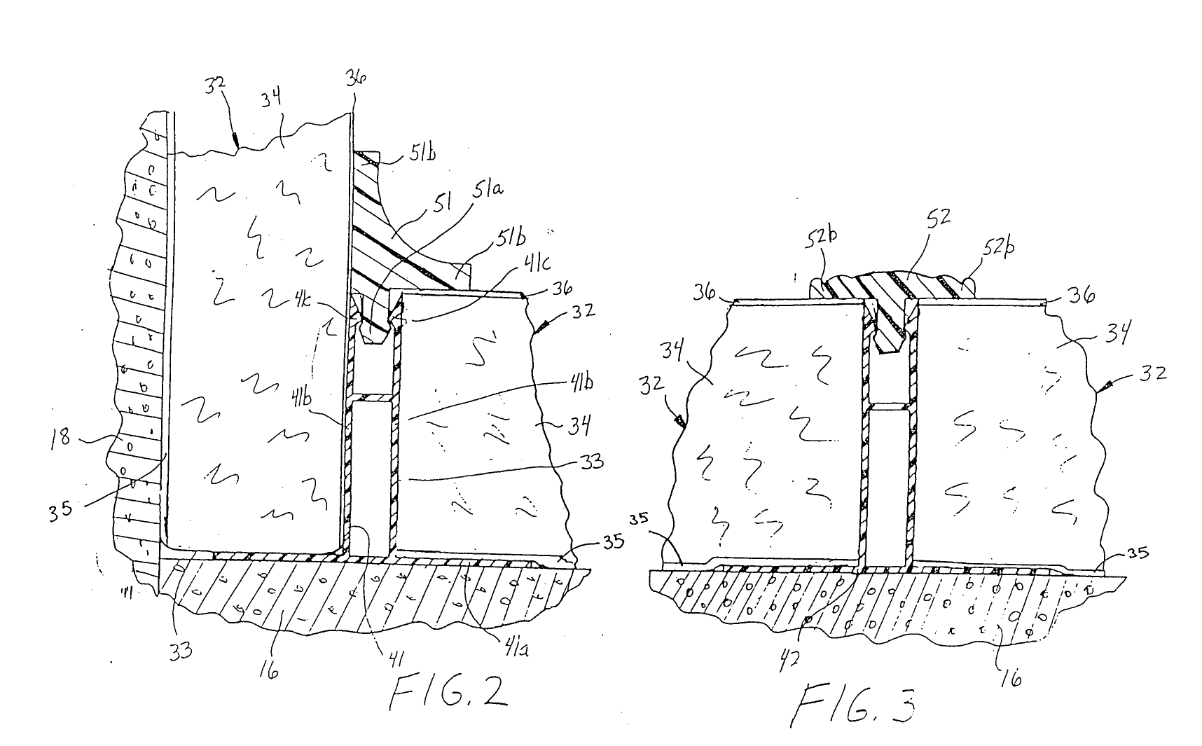

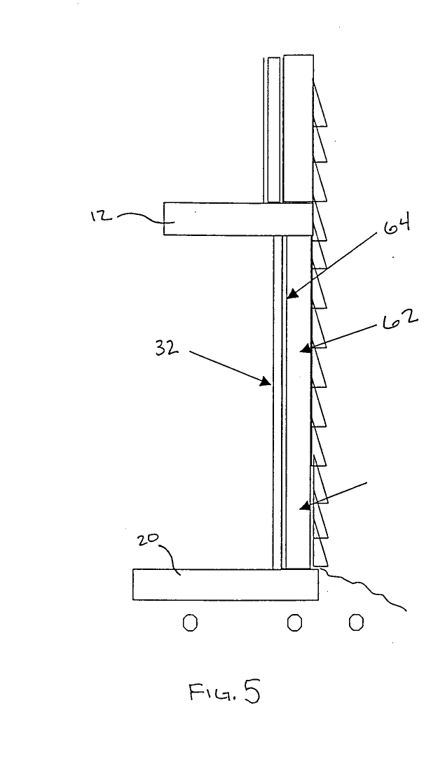

The finished room 10 further includes a room finishing system 30 which includes a plurality of first frame members 40 (only two of which are shown in FIG. 1 in breakaway) and a plurality of second frame members 50. As will be described further hereinbelow with reference to specific embodiments of the first and second frame members 40, 50 shown in FIGS. 2-6 and 8, the first frame members 40 attach to the wall 14 and each include a first snap-in connector. The second frame members 50 each include a second, mating snap-in connector, and each of the second connectors is releasably connected to one of the first connectors of one of the first frame members 40. The first and second frame members 40, 50 are preferably composed of a plastic material, such as polyethylene, polypropylene, polyvinyl chloride, or polystyrene, with a preferred plastic being polyvinyl chloride, or could be composed of a metal material. A plastic is generally preferred over a metal to reduce the rate of heat conduction through the frame members 40, 50. The outer surfaces 60 of the second frame members 50 are preferably treated in a manner well-known in the art such that they present a decorative finish, such as simulated wood grain finish.

The room finishing system 30 further includes a plurality of insulation panels 32 composed of an insulating material 34, and preferably a decorative fabric 36 attached to an outer surface of each of the insulation panels 32. Each of the insulation panels 32 is located between at least two of the first frame members 40, as will be discussed further hereinbelow with respect to a preferred method of the present invention. The insulating material is preferably a board product, such as a foam insulation board or a fibrous insulation board, sold in standard sizes, such as 4 ft. by 8 ft. (______ m by ______ m) by 2.5 in. (______ cm) thick in the U.S.

If a foam insulation board is used, a preferred board would be constructed from a resilient melamine foam such as a melamine foam sold under the trademark BASOTECT by BASF. If a fibrous insulation board is used, a preferred board is a 700 Series glass fiber insulation board available from Owens Corning, with a 703 Series board having a density of at least about 3 lb/ft³ (______ kg/m³) particularly preferred. Such glass fiber insulation boards are composed of glass fibers having a binder thereon which has been cured to bind the fibers into a matrix. For densities above about 2.25 lb/ft³ (______ kg/m³), boards of such bindered glass fibers are relatively rigid, meaning that they generally support their own weight when stood on their end and do not sag by any significant amount when left in such a position for a long period of time. It is preferred that the insulation material 34 and thus the insulation panels 32, whether they are foam or fibrous, be relatively rigid so that the panels 32 maintain their shape and thus an acceptable appearance over time, and that they are tackable, i.e., that they are strong enough to hold the weight of a picture or other decorative hanging by means of one or more nails or tacks pushed into the panels 32. It should be understood, however, that because such boards are preferably made from a resilient melamine foam or a fibrous material, they have a generally soft, resilient surface and are relatively acoustically absorptive over a midrange of audible frequencies, i.e., a range including human speech, television programs, etc.

The fabric 36 can be any type of decorative covering, such as natural or artificial fiber fabric. A durable fabric is preferred that, when combined with the insulation material 34, will pass relevant UL flame and smoke spread tests. Preferred fabrics include a fabric sold under the name WEBCORE by Gencorp, a fabric sold under the name JEWEL by Land Fabrics and a fabric sold under the name ELGIN from Guilford. Other alternative coverings include a solid vinyl wallcovering, such a covering in combination with a fabric, standard commercial insulation facings, or sprayed-on, dipped, roll-coated, etc. facings. The fabric 36 preferably extends over the front and the top, bottom and side edges of the insulation panel 32, and is fastened to the back of the insulation panel 32, such as by stapling, stitching or adhesive 31. The fabric may alternatively extend over the front of the insulation panel 32 and be fastened to the top, bottom and side edges thereof, or may simply be adhered over the entire front face of the insulation material 34.

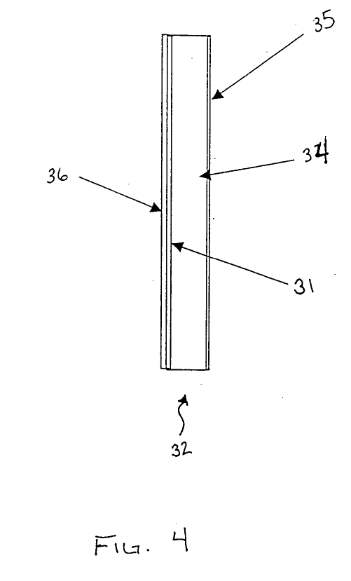

Particular embodiments of the first and second frame members will now be described in connection with FIGS. 2 and 3. As shown in FIG. 2, an inside corner of the room 12 formed between the first wall 16 and the second wall 18 is finished by means of a first corner frame member 41 attached to the first wall 16, and a second corner frame member 51 releasably connected to the first corner frame member 41. The first corner frame member 41 includes a base plate 41a through which nails can be driven or on which other attachments means such as adhesives, etc. can be used to attach the first corner frame member 41 to the first wall 16. As shown in FIG. 2, the releasable connection between the first and second corner frame members 41, 51 can be achieved by means of a pair of thin flanges 41b attached to the base plate 41a of the first corner frame member 41, which flanges each include a catch 41c thereon to form a female connector, and a connection member 51a of the second corner frame member 51 which forms a male connector and snaps into and between the catches 41c such that the catches 41c releasably retain the connection member 51a therebetween. Alternatively, the releasable connection could be achieved by other arrangements of elements, such that the first corner frame member 41 bore a male connector and the second corner frame member 51 bore a female connector, or by other types of snap-in connectors, or by fast-release or other types of connectors. The use of thin flanges 41b additionally helps to reduce the overall cross sectional area of the direct paths of thermal conduction between the first wall 16 and the second corner frame member 51, and thus to improve the overall R value of the finished system.

The second corner frame member 51 includes a pair of retaining arms 51b. As shown in FIG. 2, each retaining arm 51b extends outwardly such that, when the finishing system 30 is assembled, at least a portion of a respective insulation panel 32 is located between each retaining arm 51b and one of said first and second walls 16, 18. The retaining arms 51b and thus the second corner frame member 51 thereby retain the insulation panels 32 adjacent the first and second walls 16, 18. It should be noted that, because the retaining arms 51b each extend across a portion of a respective insulation panel 32, there is a relatively large margin of error available to an installer with respect the proper sizing of the insulation panels 32 and the placement of the first and second corner frame members 41, 51. In other words, there can be a relatively sizable gap between the end 33 of an insulation panel 32 and, respectively, the first wall 16 or the flange 41b of the first corner frame member 41, and the finished wall will still have an attractive appearance because the gap will be hidden behind a respective retaining arm 51b. This feature of the finishing system 30 of the present invention allows the installer to spend less time very carefully measuring where to attach a first frame member 40 or where to cut an insulation panel 32 to fit it into an odd-sized space, with little appreciable reduction of overall thermal performance.

It should be noted that although in FIG. 2 the first corner frame member 41 is shown as being attached to the first wall 16, the first corner frame member 41 could alternatively be attached to the second wall 18 and the second corner frame member 51 could be rotated 180 degrees (i.e., turned upside down) and the finishing system would work equally well. It also should be noted that in the preferred embodiment of the invention illustrated in FIGS. 2-6 and 8, several of the first frame members 40 are constructed identically for ease of manufacturing purposes and to simplify distribution and inventory issues. However, these first frame members 40 are numbered separately for ease of description, and it should be understood that variations in the designs of particular first frame members 40 could occur and remain within the scope of the present invention.

FIG. 3 illustrates a portion of the room 10 along the first wall 16 spaced from the corners of the room 10. FIG. 3 is thus illustrative of any area in which two insulation panels 32 abut along the same wall, and need to be retained against the wall in an aesthetic, easy to install manner. As shown in FIG. 3, two insulation panels 32 are retained adjacent the first wall 16 by a first vertical divider frame member 42 and a second vertical divider frame member 52 that are releasably connected. It should be understood in FIGS. 2 and 3 that many features of the finishing system 30 are the same regardless of the portion of the room 10 that is under consideration. Thus it should be assumed that the attachment of a first frame member 40, the releasable connection to a second frame member 50, the operation and advantages of the retaining arms of the second frame member 50, and the potential modifications thereto discussed herein all apply to the following discussions of these drawing figures.

The first vertical divider frame member 42 is preferably identical to the first corner frame member 41, and the second vertical divider frame member 52 includes two retaining arms 52b. In general, the retaining arms 52b and thus the second vertical divider frame member 52 maintain the insulation panels 32 in positions adjacent the first wall 16 and maintain an aesthetic interface between the two insulation panels 32.

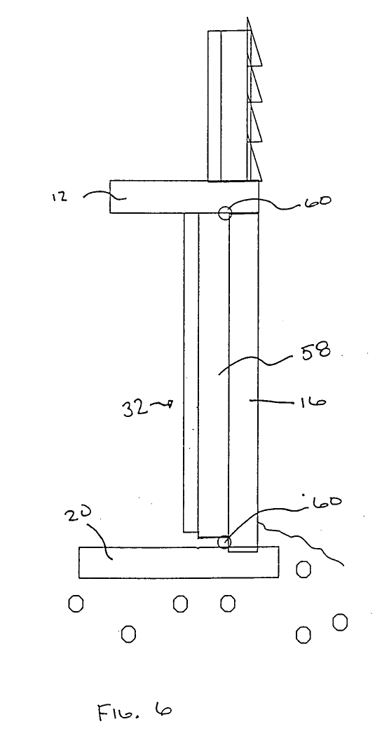

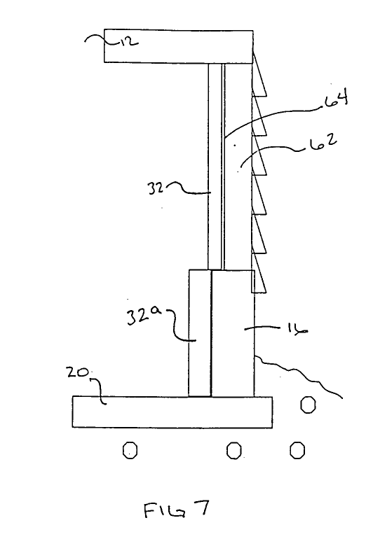

The present invention provides a finished faced insulation system for use where a reduced thickness is desired for interior applications for walls not requiring thermal insulation (non-thermal gradient walls) as shown in FIG. 5 and for the interior of walls where thermal insulation is required (thermal gradient walls) as shown in FIG. 6. The insulation system of the present invention is also suitable for use on masonry walls, frame construction walls, and combined construction walls (knee-walls) as shown in FIG. 7.

The present invention utilizes components that are not affected by moisture vapor and is intended for use in basements of residential buildings. The system is to allow moisture to pass through the fabric faced fiberglass panel and allows any water or water vapor at the basement wall to evaporate into the room interior. The vapor transmission rate of the faced fiberglass panel should be high enough to allow the insulation to dissipate moisture into the basement space such that the basement wall and the fabric faced fiberglass panel becomes dry prior to the next heating or cooling season, thus eliminating moisture build up in the wall system. The fabric faced fiberglass panel may be used to providing a thin, flat, rigid aesthetically pleasing product due to it's reinforced backside facing, fiberglass core material, and fabric exposed surface facing. The low R-value of the product allows use directly applied to a vapor barrier film on frame wall construction providing an insignificant effect on the dew point temperature of the vapor barrier film thus keeping the wall system dry.

The fabric faced fiberglass panel 32 includes a fiberglass core 34, a backing facer 35 on the rear surface of the fiberglass core and a fabric facing 36 on the front surface of the fiberglass core. The backing facer 35 may be a glass mat facer with weight between 10 and 40 lbs per ream (2880 Ft²). The facer may be adhered to the core 34 either during fabrication by introducing the facer 35 to the forming section of a glass wool process or prior to curing the glass wool to form a board. Alternatively, the facer 35 may be laminated to the core 34 by the use of adhesive after formation of the core. Higher mat facer weights are acceptable but may be cost prohibitive in general use. Preferably the mat facer has a machine direction (MD) tensile strength of 3.0 lbs/inch (according to TAPPI-494), and a machine direction/cross direction (MD/CD) tensile strength ratio of 4:1 or less. Suitable facers are polyester, vinyl, or polyolefin (polyethylene or polypropylene) spunbonded facer with weight between 0.75 oz/yd² and 2.7 oz/yd², having a MD minimum tensile strength of 10 lbs/in, a MD/CD ratio of 2:1 or less, and a maximum air permeability of 1070 (according to the Frazier Air Permeability Test). Another suitable facer is a foil-scrim-kraft (FSK) composite facer preferably including an aluminum foil of at least 0.0003″ thickness, a flame retardant adhesive, reinforcing glass fiber yarns, and at least 20 lb/ream weight kraft paper, a maximum perm rating of 0.04, minimum MD tensile strength of 40 lbs/inch, a MD/CD ratio of 3:1, a flame spread rating maximum of 25 and smoke generation of 450 (per ASTM-E84 Smoke Generation Test). According to another embodiment of the invention a vinyl media may replace the foil in the composite facer.

One suitable insulation core 34 may be formed of a fiberglass insulation with density between 4.0 lbs/ft³ to 6.0 lbs/ft³, R-value between R1 and R7, thickness between ¾″ and 1½″, fiber diameter between 20 and 45 hundred thousandths (HT), a phenolic or polyacrylic binder of between about 10% and 20% by weight of the insulation 34, minimum flexural rigidity of 400 lb/ins and a minimum compressive strength of 500 psf.

Typically a layer of adhesive 31 is used to bond the facing to the fiberglass core 36. The adhesive preferably has a flame retardancy of less than 25 flame spread and 450 smoke generation (per ASTM-E85), applied at the rate of between 2 gms/ft² and 8 gms/ft².

One preferred fabric facing 36 is a woven polyolefin (polypropylene or polyethylene). Other suitable facings are nylon, or polyester material or any combination above, either with or without and acrylic coating. Preferably the facing has an airflow rate of 760 mks Rayls or greater (per test method ASTM C522), weight of between 1.0 and 2.0 oz/ft², water vapor permiance of between 20 and 100 perm and preferably between 50 and 70 (per test method ASTM-E96), a passing abrasion resistance as per ASTM-D3884, MD tensile strength of between 150 and 300 lbs/inch, maximum MD/CD ratio of 2:1, a bacterial resistance with no growth (per test method ASTM-G22), and a maximum moisture regain of 1.0 (per test method ASTM 2564).

It is common for interior basement rooms to share a common doorway. If standard 2½″ products are used the overall wall thickness is greater than commercially available door jamb kit dimensions designed for 3.5″ or 5 and ⅝″ stud walls and specialty door jambs must be fabricated. By using this invention, a thinner wall construction is possible to allow the use of standard door kits available in the marketplace with 2.5″ and 3.5″ steel and wood studs.

The fabric 36 provides aesthetics, abrasion resistance, cleanability, toughness, resiliency, rigidity, and elimination of occupant exposure to the fiberglass media. An integral thin wall core composed of fiberglass insulation at a density in the range of 2.5 pcf to 7.0 pcf and thickness between ¼″ and 1½″ to provide a porous insulation media for sound absorption, acoustic barrier STC performance, compressive strength, and handleability. The material will also comprise of an integral reinforcement substrate to provide flexural rigidity. A porous glass matt facing providing superior fire test performance or spunbonded polymeric materials such as polyester, polyethylene, polypropylene, or nylon for applications where acoustic STC performance is not required and where flame spread and smoke generation is not limited. A non porous media such as a metallic foil film, foil-kraft, foil-kraft-scrim, or vinyl-kraft-scrim for applications involving higher acoustic STC performance.

As shown in FIG. 6 thermal gradient walls applications exist for an insulating system which provides control of moisture and temperature within the insulation system to avoid condensation issues which are prevalent in existing basement insulation system designs. By using the present invention in both above grade and below grade basement walls there is an opportunity to provide a total insulation system R value between R11 and R41 for a product which offers improved aesthetics, as well as functional control of vapor transmission rates and airflow rates to maintain vapor pressures above dew point conditions for each substrate in the insulating system thus minimizing the potential for condensation to occur within the composite wall system. This art is accomplished through the use of the following construction system:

A composite construction insulation panel of a fabric adhered to the room interior surface of the fiberglass core material with integral reinforcement facer on the panel back surface. Additionally, thermal insulation, vapor transmission rate, and controlled air flow rate

When used in conjunction with a separate layer of insulation such as foam board 58, or multiple layers of foam board. The insulation can be utilized with total R-values between R3 and R22 or more and a thickness between ½″ and 3″. The various R-values can be used to provide thermal control to maintain dew point temperatures at higher levels than temperatures to prevent condensation in the insulation system. The insulation may be a foamed polystyrene, polyisocyanurate, or similar construction either with or without integral vapor retarding facers to provide vapor control. The foam may include a sheet of fire rated material such as drywall is required over the foam to achieve fire rating. Polyisocyanurate foam panels such as Thermax available from Dow (Midland, Mich.) is available in thicknesses of ½″ (R-3.6) to 3″ (R-21/6) and includes various glass fiber reinforcements and foil facings to improve fire rating.

Affixing foam material 58 to the basement foundation wall either; with Frame Members 42, 52 or by use of sealant 60, foam tape, self impaling fasteners or adhesive to adhere the foam boards to the masonry surface, by foam board fasteners commercially available, or any combination of the above methods. Regardless of the method of affixing the foam to the masonry, the foam is to be sealed to the masonry to provide a continuous vapor seal around the foam panels and to likewise seal the foam to the masonry wall. An alternate method of sealing boards is the use of vapor retardant sealant tape to seal all board joints and provide a vapor seal to the wall surface.

The basement foundation wall 16 may consist of a masonry wall (block or poured concrete), wood frame construction 16, or combination of wood frame 62 and masonry wall 62 (referred to herein as a knee-wall). The kneewall (FIG. 7) includes a 2.5 inch laminated fiberglass insulation described in the Aloi et al. patent, set forth above. The wood frame walls may be insulated with faced or unfaced insulation with the R-value defined by local building codes. For the purposes of Example 1 and 2 unfaced, fiberglass insulation having an R-value of 19 was used to perform the dew point analysis.

This dew point analysis of the following examples is based on the 1993 ASHRAE Fundamentals Handbook Chapter 20. Each example includes an environmental conditions table, a summary of the wall construction, the r-value of each component of the wall and a mathematically modeled value for the temperature at the interface of each component. Also included in each Example is a graph showing the temperature at the interface as compared to the dew point (the possibility for condensation exists when the actual temperature is less than the dew point as shown in example 3).

The wall components of Example 1 include the laminated panel of the present invention. 1.75 inches of Thermax Foam, an unfaced R-19 fiberglass batt 7/16 inches of oriented strand board (OSB), and wood siding.

ENVIRONMENTAL CONDITIONS

| | TEMP. | R.H. |
|---|---|---|
| | (F.) | (%) |
| INTERIOR → | 68.0 | 50.0% |
| EXTERIOR → | 5.0 | 80.0% |

SYSTEM ASSEMBLY

| | | | Surface | Dew | |
|---|---|---|---|---|---|
| | | Rep | Temp. | Temp. | Accum. |
| Component | R-value | Value | (Inside/Outside) | (Inside/Outside) | (oz/day * sf) |
| Air Still Heat Flow Horiz. | 0.68 | 0.01 | 68.0/66.8 | 48.8/48.8 | 0.0 |
| Laminated Panel | 3.00 | 0.01 | 66.8/61.7 | 48.8/48.8 | 0.0 |
| 1.75″ ThermaxFoam | 12.60 | 33.33 | 61.7/40.2 | 48.8/6.8 | 0.0 |
| Unfaced R-19 Fiberglas Batt | 19.00 | 1.00 | 40.2/7.7 | 6.8/6.4 | 0.0 |
| 7/16″ OSB | 0.62 | 1.40 | 7.7/6.7 | 6.4/1.7 | 0.0 |
| Wood Siding | 0.81 | 0.50 | 6.7/5.3 | 1.7/−0.3 | 0.0 |
| Outside Air Film | 0.17 | 0.01 | 5.3/5.0 | −0.3/−0.4 | 0.0 |
| TOTAL R-VALUE = | 36.88 | | | | |

[image]

Example 2, which corresponds to FIG. 6, includes the laminated panel of the present invention. 1.75 inches of Thermax Foam, and an eight inch block wall, no condensation occurs according to the accumulated moisture load

SYSTEM ASSEMBLY

| | | Rep | Actual | Dew | Accum. |
|---|---|---|---|---|---|
| Component | R-value | Value | Temp. | Temp. | (oz/day * sf) |
| Air Still Heat | 0.68 | 0.01 | 68.0/65.5 | 48.8/48.8 | 0.0 |
| Flow Horiz. | | | | | |
| Laminated Panel | 3.00 | 0.01 | 65.5/54.7 | 48.8/48.8 | 0.0 |
| 1.75″ | 12.60 | 33.33 | 54.7/9.2 | 48.8/1.4 | 0.0 |
| ThermaxFoam | | | | | |
| 8″ Block | 1.00 | 0.40 | 9.2/5.6 | 1.4/−0.3 | 0.0 |
| Outside Air Film | 0.17 | 0.01 | 5.6/5.0 | −0.3/−0.4 | 0.0 |
| TOTAL | 17.45 | | | | |

[image]

Example 3 shows an 8″ bare masonry wall with potential for condensation

SYSTEM ASSEMBLY

| | | Rep | Actual | Dew | Accum. |
|---|---|---|---|---|---|
| Component | R-value | Value | Temp. | Temp. | (oz/day * sf |
| Air Still Heat | 0.68 | 0.01 | 68.0/44.8 | 48.8/48.2 | 0.262 |
| Flow Horiz. | | | | | |
| 8″ Block | 1.00 | 0.40 | 44.8/10.8 | 48.2/3.0 | 0.000 |
| Outside Air Film | 0.17 | 0.01 | 10.8/5.0 | 3.0/−0.4 | 0.000 |
| TOTAL | 1.85 | | | | |
| R-VALUE = | | | | | |

[image]

The advantages of the present invention are easily evident. The present invention provides thermal insulation benefits in an aesthetic room finishing system. In addition, the finishing system of the present invention is very easy to install and allows for a relatively large margin of error on the part of the installer. These features make it possible for a professional installer to reduce its labor costs considerably.

The present invention additionally can be advantageous for the builders and owners of new homes. Because the system is nondestructively modular, i.e., because it includes modular panels that can be removed and replace very quickly and easily in a nondestructive manner, the builder of a new home can finish a room such as a basement using the present invention without fear of greatly aggravated costs in the event of a foundation crack or leak. Although the preferred boards of the present invention are rigid, as defined, they are formed of materials such as melamine foam or glass fiber insulation that are soft, resilient and relatively acoustically absorptive of a midrange of audible frequencies. These features can provide a potentially safer playroom area for children, as well as a more acoustically desirable environment. The resiliency of the insulation panels allows the system to be placed directly over existing wires and other small obstacles, because the panels can conform to a certain extent to the wall surface they abut. In addition, the resiliency and acoustical absorptiveness of the insulation panels makes the finishing system of the present invention particularly suitable for finishing of such commercial rooms as gymnasiums, classrooms and day cares.

The principles, a preferred embodiment and the mode of operation of the present invention have been described in the foregoing specification. However, the invention which is intended to be protected is not to be construed as limited to the particular embodiment disclosed. The embodiment is therefore to be regarded as illustrative rather than restrictive. Variations and changes may be made by others without departing from the spirit of the present invention. Accordingly, it is expressly intended that all such equivalents, variations and changes which fall within the spirit and scope of the present invention as defined in the claims be embraced thereby.

What is claimed is:

1. A laminated insulations system comprising:
an insulative core having a first surface and a second surface, said first surface being suitable for exposure to an interior of a room, said second surface being suitable for being placed adjacent a wall;
a decorative facer adhered to said first surface;
a structural facer adhered to said second surface.

2. The laminated insulations system of claim 1, further comprising and adhesive between said decorative facer and said first surface.

3. The laminated insulations system of claim 1 wherein said decorative facer is a polyolefin.

4. The laminated insulations system of claim 1 wherein said structural facer is a glass mat.
